(19) United States
(12) Patent Application Publication
(10) Pub. No.: US 2007/0005993 A1
(43) Pub. Date: Jan. 4, 2007

(54) System and method of theft prevention for an electronic device by lowering quality-of- service

(76) Inventor: Lambert Hubert Agustin Jacobs, Bilzen (BE)

Correspondence Address: PHILIPS INTELLECTUAL PROPERTY & STANDARDS, P.O. BOX 3001, BRIARCLIFF MANOR, NY, 10510, US

(21) Appl. No.: 10/555,851

(22) PCT Filed: Apr. 29, 2004
(86) PCT No.: PCT/IB04/01449

§ 371 Date: Nov. 7, 2005

Related U.S. Application Data
(60) Provisional application No. 60/469,059, filed on May 8, 2003.

(51) Int. Cl. G06F 1/00

(52) U.S. Cl. 713/300

(57) ABSTRACT

This invention provides a system and method for preventing theft of an electronic device that degrades the QoS of at least one function of the device to a pre-determined or “locked” status if pre-set authentication information is not input and validated. The method is carried out by control component on-board the electronic device and the pre-set authentication information is stored internally to the electronic component. Alternatively, the pre-set authentication information is stored in external memory (such as NOR flash, NAND flash, EEPROM, MRAM, etc). The means for inputting the authentication information to be verified against this pre-stored authentication information comprises the device's normal input means or dedicated input means (e.g. a remote control for anti-theft purpose). For example, if the QoS degraded is an internal clock frequency of a laptop computer, the keyboard of the computer serves as one input means and the screen as a display means for requesting that the authentication information be input. QoS is noticeably degraded to discourage a thief, e.g., alternating between low QoS and high QoS.

This invention relates to a system and method for lowering or “locking” one or more Quality of Service (QoS) parameters of an electronic device to make the electronic device unattractive as a theft target More particularly, the system and method of the present invention lowers or “locks” at a low level at least one QoS parameter of an electronic device so that the device functions below its normal quality of service and can be considered to be non-functional, thereby rendering the device unattractive as a theft target

There are more and more electronic devices being developed and finding a ready market, such as Laptops, Game-Consoles, Personal Digital Assistants (PDA), Mobile Phones, Storage Containers, Digital Cameras, etc. These electronic devices are quite attractive theft targets as they are easy to remove and carry and difficult to identify as having been stolen from their outward appearances.

One commonly used approach is to somehow control access to the functionality of electronic devices in order to discourage theft of such devices. Such access control is especially applicable to personal portable electronic devices and several control techniques have been developed. In addition to controlling access, lowering power consumption is another very desirable goal for such portable devices, in order to conserve on-board battery power.

Japanese patent application publication no. JP-2001175368 A to Masanobu, teaches conserving battery power by low-powering a PDA by lowering the CPU clock frequency by a factor of 2 so that power consumption is lowered at initial start-up and during the initial memory data initialization phase. A user has no control over lowering the frequency and QoS is neither a goal nor is it affected in any way.

Japanese patent application publication no. JP-05035689 A to Yukio, teaches a hardware card inserted by a user to identify the user as authorized for access, a special function that reads the inserted card and interrupts all or a part of the system power of a portable computer if the user is not authorized for access. A user does not provide an authentication input and service interruption rather than QoS degradation is taught by Yukio.

Japanese patent application publication no. JP-09284691 A to Mitsuhiro, teaches theft prevention by password protection wherein for a video camera the image quality, a QoS item, is degraded over time by a CPU until a correct password is entered. The password protection is enabled only by turning off the video camera off (power off), when the video camera enters a protected mode until, at power up, a correct password is entered. Mitsuhiro teaches part or all of a picture is scrambled or made missing in the protected mode.

Web site www.insight-security.com offers a “PC Access” product which combines an RF reader that is plugged into a computer, transmitter tags worn by authorized users, and software to control unauthorized access by monitoring proximity of at least one authorized user, immobilizing the computer when there is no authorized user and resuming normal processing when an authorized user comes within transmission range (and is wearing a transmitter tag).

Caveo Technology offers Caveo Anti-Theft, a software/hardware combination employing a tiny motion sensor installed somewhere in a PC. Caveo Anti-Theft operates by detecting motion, analyzing it to determine whether a threat exists, and implementing responses. Caveo Anti-Theft is independent of the computer operating system and operates whether the laptop is on or off. A password input is required to turn the laptop back on, i.e., to make the functions of the laptop available again, once the alarm has been activated by some extreme motion of the laptop.

These prior art theft and access prevention approaches require various types of modifications to the hardware and software of the devices being protected that are not appropriate for a broad array of portable electronic devices.

Thus, there is a need for a theft prevention solution that applies equally to all types of electronic devices, ranging in size from a PDA to a television, a solution that maintains the advantages cost and number of parts of these electronic devices.

The present invention provides theft prevention and applies to all electronic devices comprising a means to accept authentication information input (such as a password or a fingerprint), store pre-set authentication information, validate the input using a sequence of authentication instruction, by way of example and not limitation, against the pre-stored authentication information and initiate QoS at a level commensurate with the result of this validation, i.e., to maintain a “lock” or “unlock” the QoS parameter(s) associated with the authentication input. The present invention is applicable to such electronic devices as Laptops, PDAs, Game-Consoles, portable DVD-players as well as televisions, car radios, graphics terminals, and other electronic devices comprising means to accept and validate authentication information inputs against pre-stored authentication information using sequences of authentication instructions in the electronic device. The general idea is to make these electronic devices less attractive for robbery by incorporating in them a means to lower or “lock” one or more QoS (Quality of Service) parameters of the device to a previously determined “locked” state after some number of low-power modes (e.g., after a pre-set (e.g. 5) or a variable number of standby, or power-off modes). The normal or “unlocked” state of the QoS parameter(s) can be regained when the device is “unlocked” after acceptance and validation of authentication information.

One embodiment of the present invention uses clock frequency as such a QoS parameter by lowering or “locking” at a lower level the effective (internal or external) clock frequency (the QoS parameter) of an on-board CPU (e.g. via phase-locked loop (PLL) or clock divider), in one embodiment when it is powered-off or, in the case where a CPU is never switched off, when it runs at a very low clock-speed or the CPU-load is below a certain threshold (e.g. 5%) for a certain amount of time (e.g. 1 minute). It should be noted that the term CPU used herein is meant to cover pure CPUs, chips that are a mix of analog circuitry, digital circuitry, (programmable or not) glue logic, and zero or more CPU-cores (e.g. ARM, MIPS, x86, . . . ). Other embodiments lower some other QoS parameter for the electronic device, e.g., picture quality of a television or sound quality of a stereo or radio.

In a preferred embodiment, existing components are modified to perform the automatic QoS parameter “locking” at low-power mode and “unlocking” upon acceptance and validation of authentication information, as described above. Alternatively, additional control components are provided to perform the automatic QoS parameter “locking” at low-power mode and “unlocking” upon acceptance and validation of authentication information, as described above. Thus, the present invention is both simple and very safe. It is safe because the different “parts” of the “lock” (e.g., the PLL and the storage and the comparison logic) are in the same chip. If physically different components were involved, these different components would have to communicate with each other, and that is easier to interdict Inside a chip, this is “impossible”.

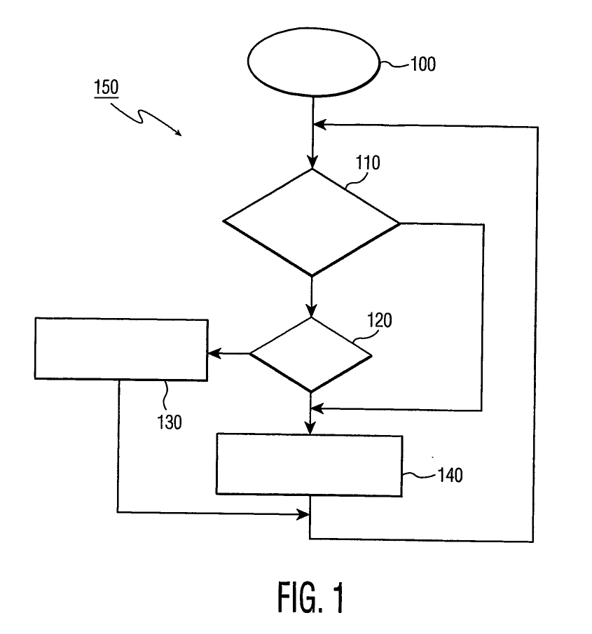

FIG. 1 illustrates a process flow for an embodiment of the present invention in which boot-up of a portable device uses a control component modified according to the system and method of the present invention.

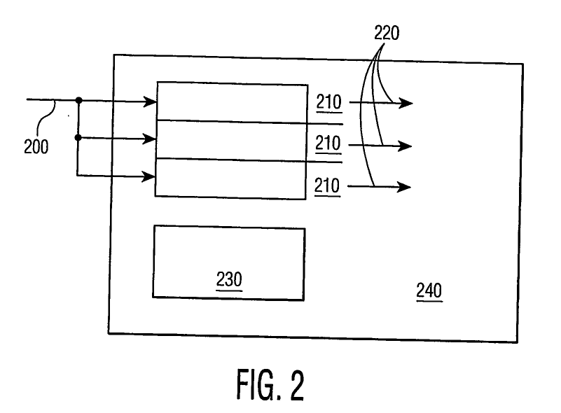

FIG. 2 illustrates components required to implement the process illustrated in FIG. 1.

The present invention is a system and method such that when an electronic device is powered-off or enters a low-power level mode, at least one QoS parameter is “locked” at a degraded level and when the electronic device is taken out of this low-power level mode, the “locked” state of this at least one QoS parameter is maintained until pre-set authentication information is accepted and validated to “unlock” it or partially unlock it.

In a preferred embodiment, a pre-set authentication information is stored within an on-board control component such as a CPU, microprocessor, digital signal processor (DSP), application-specific integrated circuit (ASIC), programmable logic device (PLD), and field programmable gate array (FPGA) in a non-volatile memory (e.g. NOR flash or NAND flash or MRAM or FRAM) inside the control component and is associated with the QoS parameter of control component clock frequency. The locking and unlocking of access to a normal control component frequency can be enabled from a low power mode of the device containing the control component. In this embodiment, it is assumed that the control component has an on-board clock-divider (or PLL or similar functioning component) which at low-power mode puts the internal frequency of the control component to a low frequency, i.e., “locks” this QoS parameter at a low level. Alternatively, a control component is provided, such as a CPU, microprocessor, digital signal processor (DSP), application-specific integrated circuit (ASIC), programmable logic device (PLD) and field programmable gate array (FPGA). However, this “lock” frequency must be high enough to allow input of the authentication information (e.g., from a keyboard, or from a remote control device, or biometric device (fingerprint or eye-scan), which in practice means it can be very low. Once input, the authentication information is compared to the internal (hidden) authentication pre-stored in the control component and in case of a match, the control component turns its internal frequency higher, i.e., “unlocks” this QoS parameter. In case of a mismatch, the internal frequency (QoS parameter) of the control component remains low, i.e., “locked”, and the whole system remains very slow, i.e., “locked” (too slow to run the applications the device containing the control component was intended for). This should discourage theft of the electronic device that is exhibiting slow or “locked” operation.

FIG. 1 illustrates a preferred embodiment of an “unlock” sequence. At step 100 the “unlock” procedure is performed for each “locked” QoS parameter by determining if authentication information has been input at step 110, comparing the input authentication information to corresponding stored pre-set authentication information at step 120 and “unlocking” the QoS parameter at step 130 or otherwise continuing the “locked” state of the QoS parameter. In this way subsets of QoS parameters might be made unavailable on a selective basis and, furthermore, multiple authentication information inputs can make it more difficult to compromise protection of this type, i.e., guess the authentication information to be input, than a single input. For example, some function of an electronic device is to be made available on a limited basis, e.g., hard drive or Internet access.

FIG. 2 illustrates the system and method of the present invention as applied to multiple internal frequencies 220 which can each be set to a sufficiently low state so as to achieve a poor QoS for each of the frequencies and the quality of service of their associated functions.

Authentication information can be associated with each said internal frequency and pre-set authentication information is preferably stored in the control component's on-chip non-volatile memory 230 but can also be stored in external memory (such as NOR flash, NAND flash, EEPROM, MRAM, etc). Many control components (such as the CPUs on a motherboard of a PC) can functionally operate at many frequencies. In a preferred embodiment the external clock frequency (the 4 MHz) cannot be driven up by about the same factor as the division factor in “locked QoS mode so that a thief cannot turn up the external clock frequency (by the same factor) to work around the protection provided by the present invention. In an alternative embodiment, the control component has additional circuitry/control logic to check that the external clock speed has not been driven up.

In another embodiment, the system and method of authentication information protected QoS parameters of the present invention are applied to a graphics chip. In this embodiment, the video resolution (number of pixels and lines) and/or color depth (e.g., 24-bit RGB) and/or refresh-rate (e.g. 90 Hz) is set to a low or “locked” state (e.g., 320×200 pixels, 256 colors, 60 Hz) with a corresponding authentication information enabled high or “unlocked” state (e.g., 1024×768 pixels, 24-bit RGB, 90 Hz).

In another embodiment, the system and method of authentication information protected QoS parameters of the present invention is applied to a television set, or a device intended to be attached to a television set (such as a cable or satellite set-top-box decoder, or a digital or analog video-recorder/player). In this embodiment, the authentication information is entered via the remote control devices, and the low QoS or “locked” state comprises for example a black and white picture or alternating low/high Quality (e.g. 2 seconds low-Q, 2 seconds high-Q), which makes it much easier to detect a theft, and/or no sound or mono instead of stereo, or sound from only one speaker, or sound from alternating speakers over time (e.g. left for 2 seconds, right for 2 seconds), and/or other features (such as 100 Hz TV), and authentication information enabled QoS or “unlocked” state comprises a normal color picture with sound. In this embodiment, the pre-set authentication information is preferably stored inside the main chip on the motherboard.

Alternatively, there is not just a “locked” state at low QoS, or and “unlocked” state at high QoS, but “locked” can also mean “alternating between low QoS and high QoS, in a way that is very annoying and precludes theft, and is very easy to detect.

In another embodiment, the system and method of authentication input protected QoS parameters of the present invention is applied to a stereo or a stereo cassette player or CD/DVD player or an MP3 player or an audio player with a Hard Disk Drive, wherein the authentication input can be made via buttons and the lower or “locked” QoS comprises monaural sound or normal sound with synthetic noise added. In this embodiment the control component controlling the sound output stores the pre-set authentication information and added functionality to perform the QoS locking and unlocking, by way of example, a sequence of authentication instructions. Alternatively, the pre-set authentication information can also be stored in external memory (such as NOR flash, NAND flash, EEPROM, MRAM, etc).

In another embodiment, the system and method of authentication input protected QoS parameters of the present invention is applied to a modem with authentication information stored internal to the CPU or microprocessor or Digital Signal Processor (DSP) or application-specific integrated circuit (ASIC) and the locking and unlocking being accomplished with respect to the QoS parameter of rate of data throughput. Alternatively, the pre-set authentication information can also be stored in external memory (such as NOR flash, NAND flash, EEPROM, MRAM, etc).

In all embodiments, the system and method of the present invention maintains an obviously “locked” mode when valid authentication information has not been supplied and this “locked” mode of operation is obvious to any potential thief, a potential buyer of stolen electronic goods protected with the system and method of the present invention, and to law enforcement personnel.

The foregoing description of exemplary embodiments of the present invention has been presented for the purposes of illustration and description. It is not intended to be exhaustive or to limit the invention to the precise embodiments disclosed. Many modifications and variations are possible in light of the above teaching. It is intended that the scope of the invention be limited not with this detailed description, but rather by the claims appended hereto.

1. An apparatus for controlling the level of at least one quality of service (QoS) parameter of an electronic device, comprising:
a processor that, for said at least one QoS parameter executes a corresponding sequence of authentication instructions having at least one pre-set authentication information whenever said electronic device has entered a mode of operation selected from the group consisting of low-power mode, standby mode, and shut-down mode a predetermined number of times;
a memory coupled to said processor, said memory storing said sequence of authentication instructions and said at least one pre-set authentication information corresponding to said at least one QoS parameter,
wherein, said at least one sequence of authentication instructions accepts an externally input authentication information, validates said externally input authentication information using said stored at least one pre-set information and locks said at least one QoS parameter to an obviously non-operational level if the validation fails and unlocks said at least one QoS parameter to an operational level if said validation is successful.

2. The apparatus of claim 1, wherein said apparatus is packaged as one of the group consisting of microcomputer, digital signal processor (DSP), application-specific integrated circuit (ASIC), Programmable Logic Device (PLD), field programmable gate array (FPGA), and electronic subsystem.

3. A method for preventing theft and verifying ownership of an electronic device, comprising the steps of:
locking at a low level at least one quality of service (QoS) parameter of the electronic device;
accepting authentication information corresponding to the locked QoS parameter; and
unlocking the locked QoS parameter to an operational level when the accepted authentication information is validated against a pre-set authentication information,
wherein, the locking at a low level of the at least one QoS parameter results in the electronic device being obviously non-operational for at least one intended purpose of the electronic device thereby rendering the electronic device undesirable as a theft target, and wherein unlocking said at least one QoS parameter verifies ownership of the electronic device.

4. The method of claim 3, wherein said electronic device is a television set having a color display screen and said at least one QoS parameter is selected from the group consisting of color-depth, pixel resolution, and frame-rate of the display screen.

5. The method of claim 3, wherein said electronic device is a sound producing electronic device and said at least one QoS parameter is a quality of the produced sound.

6. The method of claim 5, wherein said sound producing electronic device is selected from the group consisting of stereo radio, stereo cassette player, stereo CD/DVD player, MP3-player, an audio player with a Hard Disk Drive, and a solid-state audio player.

7. The method of claim 3, wherein said electronic device is a modem and said at least one QoS parameter is selected from the group consisting of speed of transmission, bandwidth, number of channels, and signal-to-noise ratio.

8. The method of claim 3, wherein said locking step is performed when the electronic device enters a low-power level.

9. The method of claim 8, wherein said electronic device is a television set having a color display screen and said at least one QoS parameter is selected from the group consisting of color-depth, pixel resolution, and frame-rate of the display screen.

10. The method of claim 8, wherein said electronic device is a sound producing device selected from the group consisting of stereo radio, stereo cassette player, stereo CD/DVD player, MP3-player, an audio player with a Hard Disk Drive, or solid-state audio player and said at least one QoS parameter is quality of sound.

11. The method of claim 8, wherein said electronic device is a modem and said at least one QoS parameter is a speed of transmission, bandwidth, number of channels, and signal-to-noise ratio.

12. The method of claim 8, further comprising the steps of:
providing a control component that controls operation of said at least one QoS parameter, said control component being selected from the group consisting of microprocessor, digital signal processor (DSP) or application-specific integrated circuit (ASIC), programmable logic device (PLD), field programmable gate array (FPGA), wherein the provided control component is selected from the group consisting of an existing component of the electronic device and an additional control component;
specifying said at least one QoS parameter as at least one internal clock frequency of said control component; and
pre-storing in a non-volatile memory accessed by said control component, a pre-set authentication information corresponding to said specified at least one QoS parameter.

13. The method of claim 12, wherein said non-volatile memory is internal to said control component.

14. The method of claim 12, wherein said non-volatile memory is external to said control component.

15. The method of claim 12, wherein said pre-set authentication information is at least one pre-set authentication information corresponding to said at least one QoS parameter.

16. The method of claim 12, wherein said control component has an external frequency that cannot be driven up to render the electronic device operational for at least one intended function.

17. The method of claim 12, wherein said locking step further comprises the step of using at least one component selected from the group consisting of a phase-locked loop (PLL) and a clock divider to lower said at least one internal clock frequency.

18. The method of claim 12, wherein said control component is a graphics chip controlling a display screen and said QoS parameter is selected from the group consisting of color-depth, pixel resolution, and frame-rate of the display screen.

19. The method of claim 12, wherein said electronic device is a television set having a color display screen and said QoS parameter is selected from the group consisting of color-depth, pixel resolution, and frame-rate of the display screen.

20. The method of claim 12, wherein said electronic device is a sound producing device and said at least one QoS parameter is a quality of the produced sound.

21. The method of claim 20, wherein said sound producing electronic device is selected from the group consisting stereo radio, stereo cassette player, stereo CD/DVD player, MP3-player, an audio player with a Hard Disk Drive, or solid-state audio player.

22. The method of claim 12, wherein said electronic device is a modem and said at least one QoS parameter is a speed of transmission, bandwidth, number of channels, and signal-to-noise ratio.

23. The method of claim 3, further comprising the steps of:
providing a control component that controls operation of said at least one QoS parameter, said control component being selected from the group consisting of microprocessor, digital signal processor (DSP) or application-specific integrated circuit (ASIC), programmable logic device (OLD), field programmable gate array (FPGA), wherein the provided control component is selected from the group consisting of an existing component of the electronic device and an additional control component;
specifying said at least one QoS parameter is at least one internal clock frequency of said control component; and
pre-storing in a non-volatile memory said pre-set authentication information corresponding to said at least one QoS parameter internally to said control component.

24. The method of claim 23, wherein said pre-set authentication information is at least one pre-set authentication information corresponding to each at least one QoS parameter.

25. The method of claim 23, wherein said control component has an external frequency that cannot be turned-up to render the electronic device operational for at least one intended function.

26. The method of claim 23, wherein said locking step further comprises the step of using a component selected from the group consisting of a phase-locked loop (PLL) and a clock divider to lower said at least one internal clock frequency.

27. The method of claim 23, wherein said control component is a graphics chip controlling a display screen and said QoS parameter is selected from the group consisting of color-depth, pixel resolution, and frame-rate of the display screen.

28. The method of claim 23, wherein said electronic device is a television set having a color display and said QoS parameter is selected from the group consisting of color-depth, pixel resolution, and frame-rate of the display screen.

29. The method of claim 23, wherein said electronic device is a sound producing device and said at least one QoS parameter is a quality of the produced sound.

30. The method of claim 29, wherein said sound producing device is selected from the group consisting of stereo radio, stereo cassette player, stereo CD/DVD player, MP3-player, an audio player with a Hard Disk Drive, or solid-state audio player.

31. The method of claim 23, wherein said electronic device is a modem and said at least one QoS parameter is selected from the group consisting of speed of transmission, bandwidth, number of channels, and signal-to-noise ratio.
